(19) United States
(12) Patent Application Publication
(10) Pub. No.: US 2013/0031095 A1
(43) Pub. Date: Jan. 31, 2013

(54) ENTRY SUPPORT APPARATUS AND METHOD

(71) Applicant: Kiyoshi Takeuchi, Kanazawa (JP)

(72) Inventor: Kiyoshi Takeuchi, Kanazawa (JP)

(73) Assignee: FUJITSU LIMITED, Kawasaki-shi (JP)

(21) Appl. No.: 13/556,415

(22) Filed: Jul. 24, 2012

(30) Foreign Application Priority Data
Jul. 26, 2011 (JP) 2011-163636

(51) Int. Cl. G06F 17/30

(52) U.S. Cl. 707/737; 707/E17.089

(57) ABSTRACT

A computer-readable recording medium has an entry support program embodied therein for causing a computer to perform detecting text being entered, extracting text examples corresponding to the detected text from a storage unit, the storage unit storing text examples and frequencies of use of the text examples such that the frequencies of use are associated with the respective text examples, classifying the extracted text examples into text-example groups each containing one or more text examples based on comparison of letters included in the extracted text examples, determining display order of the text-example groups, based on the frequencies of use that are associated in the storage unit with text examples belonging to the text-example groups, and displaying the extracted text examples in the determined display order.

### CROSS-REFERENCE TO RELATED APPLICATIONS

The present application is based upon and claims the benefit of priority from the prior Japanese Patent Application No. 2011-163636 filed on Jul. 26, 2011, with the Japanese Patent Office, the entire contents of which are incorporated herein by reference.

### FIELD

The disclosures herein generally relate to an entry support program, an entry support apparatus, and an entry support method, and particularly relate to a text-entry support program, a text-entry support apparatus, and a text-entry support method for supporting text entry.

### BACKGROUND

In order to improve the operability of a PC (personal computer) or the like with respect to text entry, text examples or example texts (hereinafter referred to as “text examples”) are entered in a dictionary in advance in such a manner that these texts are associated with corresponding readings (phonetics: symbols used to represent the speech sound of text). It may be noted that in the case of the Japanese language, a reading (phonetics) is typed in, and is then converted into kanji characters (i.e., Chinese characters) in the computer or the like by character-conversion software. When a user enters a reading that represents part of a desired text, a list of text examples partially matching the entered reading will be displayed. The user then selects the text example matching the desired text from the list, thereby being able to enter the whole desired text.

The smaller the number of letters entered as a reading, the greater the advantage of use of text examples is. Namely, the smaller the number of letters entered as a reading, the greater the number of letters saved without being typed is.

On the other hand, the smaller the number of letters entered as a reading, the greater the number of text examples corresponding to the reading is. It is thus important to make it easier to find a desired text amongst numbers of text examples. For example, text examples may be displayed in the order of frequency of use.

When text examples are displayed in the order of frequency of use, however, text examples similar to each other may be displayed at positions far apart from each other, resulting in a difficulty to find a desired text example. The possibility of erroneous selection may also be increased.

In the following, specific examples will be used to explain. The following text examples are present in a text-example dictionary, for example.

Text Example 1: “a i u e o ka ki ku ke ko”
Text Example 2: “a i u e o ka ki ku ko ke”
Text Example 3: “a i sa si su se so ta ti tu”
Text Example 4: “a na ni nu ne no ha hi hu he”

In this case, the text examples 1 to 4 will be displayed upon entering the reading “a”. It is assumed that the descending order of frequency of use is as follows: the text example 1, the text example 3, the text example 4, and the text example 2. In this case, the text examples will be displayed in the following order.

Text Example 1: “a i u e o ka ki ku ke ko”
Text Example 3: “a i sa si su se so ta ti tu”
Text Example 4: “a na ni nu ne no ha hi hu he”
Text Example 2: “a i u e o ka ki ku ko ke”

A text that the user wishes to enter may be the same as the text example 2. When the order of frequency of use is used, however, it is difficult to visually recognize differences between the text example 1 and the text example 2. The user may mistakenly select the text example 1 that is similar to the text example 2 at first sight. Alternatively, the user may recognize that the text example 1 is not a desired text by checking every letter of the text example 1, and may then try to find a desired text from the remaining text examples.
[Patent Document 1] Japanese Patent Application Publication No. 6-12450

### SUMMARY

According to an aspect of the embodiment, a computer-readable recording medium has an entry support program embodied therein for causing a computer to perform detecting text being entered, extracting text examples corresponding to the detected text from a storage unit, the storage unit storing text examples and frequencies of use of the text examples such that the frequencies of use are associated with the respective text examples, classifying the extracted text examples into text-example groups each containing one or more text examples based on comparison of letters included in the extracted text examples, determining display order of the text-example groups, based on the frequencies of use that are associated in the storage unit with text examples belonging to the text-example groups, and displaying the extracted text examples in the determined display order.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating an example of the hardware configuration of an entry support apparatus according to the present embodiment;

FIG. 2 is a drawing illustrating an example of the functional configuration of the entry support apparatus according to the present embodiment;

FIG. 3 is a flowchart for explaining the operation procedure performed by an entry support unit;

FIG. 4 is a drawing illustrating an example of the configuration of a text-example dictionary;

FIG. 5 is a flowchart illustrating, an example of the steps of a text-example-list display process;

FIG. 6 is a drawing illustrating an example of the configuration of a text-example sorting area;

FIG. 7 is a flowchart illustrating an example of the steps of a display-order determining process;

FIG. 8 is a drawing illustrating an example of the result of sorting according to alphabetical order;

FIG. 9 is a drawing illustrating an example of a result obtained by classifying text examples into groups;

FIG. 10 is a drawing illustrating an example of a result obtained by sorting text-example groups;

FIG. 11 is a flowchart illustrating an example of the steps of a text-example classifying process;

FIG. 12 is a drawing illustrating an example of the configuration of a classification-rule storage unit;

FIG. 13 is a drawing illustrating an example of the way a list of text examples is displayed; and

FIGS. 14A and 14B are drawings illustrating examples of a text-example list displayed in the order of frequencies of use and in alphabetical order, respectively.

### DESCRIPTION OF EMBODIMENTS

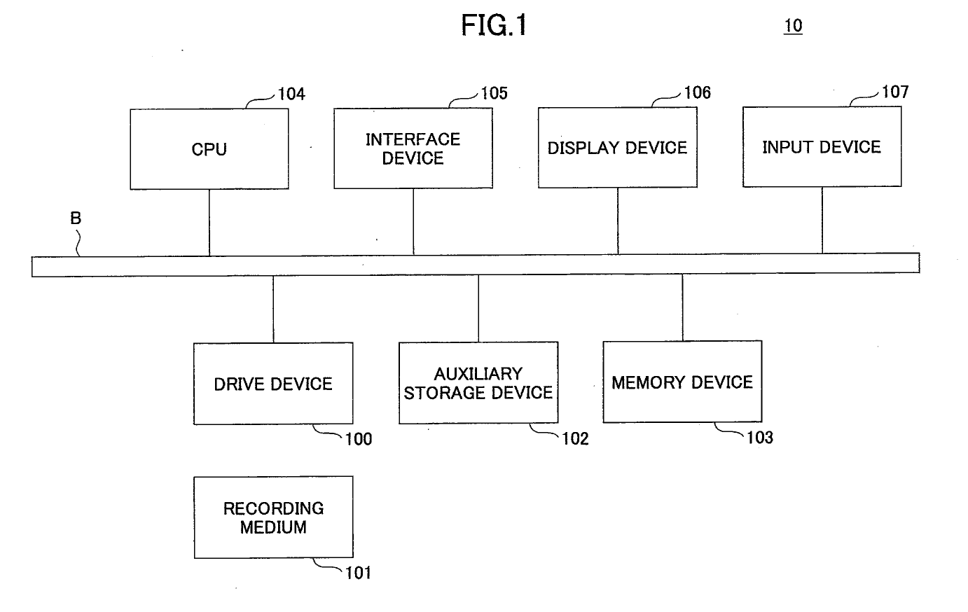

In the following, embodiments of the present invention will be described with reference to the accompanying drawings. FIG. 1 is a drawing illustrating an example of the hardware configuration of an entry support apparatus according to the present embodiment. The entry support apparatus 10 illustrated in FIG. 1 includes a drive device 100, an auxiliary storage device 102, a memory device 103, a CPU 104, an interface device 105, a display device 106, and an input device 107, which are connected together via a bus B.

Programs for implementing the functions of the entry support apparatus 10 are provided in a recording medium 101. Upon setting the recording medium 101 containing programs to the drive device 100, the programs are installed from the record medium 101 to the auxiliary storage device 102 through the drive device 100. The programs do not have to be installed from the recording medium 101, and may be downloaded from another computer through a network. The auxiliary memory device 102 stores the installed programs, and, also, stores various files and data.

The memory device 103 serves to store a program read from the auxiliary storage device 102 upon a request to execute the program. The CPU 104 serves to provide the functions of the entry support apparatus 10 according to programs stored in the memory device 103. The interface device 105 serves to provide connection with the network. The display device 106 displays a GUI (graphical user interface) based on programs. The input device 107 includes a keyboard and mouse, for example, and serves to receive various operation instructions.

Examples of the recording medium 101 include an exchangeable recording medium such as a CD-ROM, a DVD disc, and a USB memory. Examples of the auxiliary storage device 102 may include a HDD (hard disk drive) and a flash memory, for example. Either one of the recording medium 101 and the auxiliary storage device 102 can serve as a computer-readable recording medium.

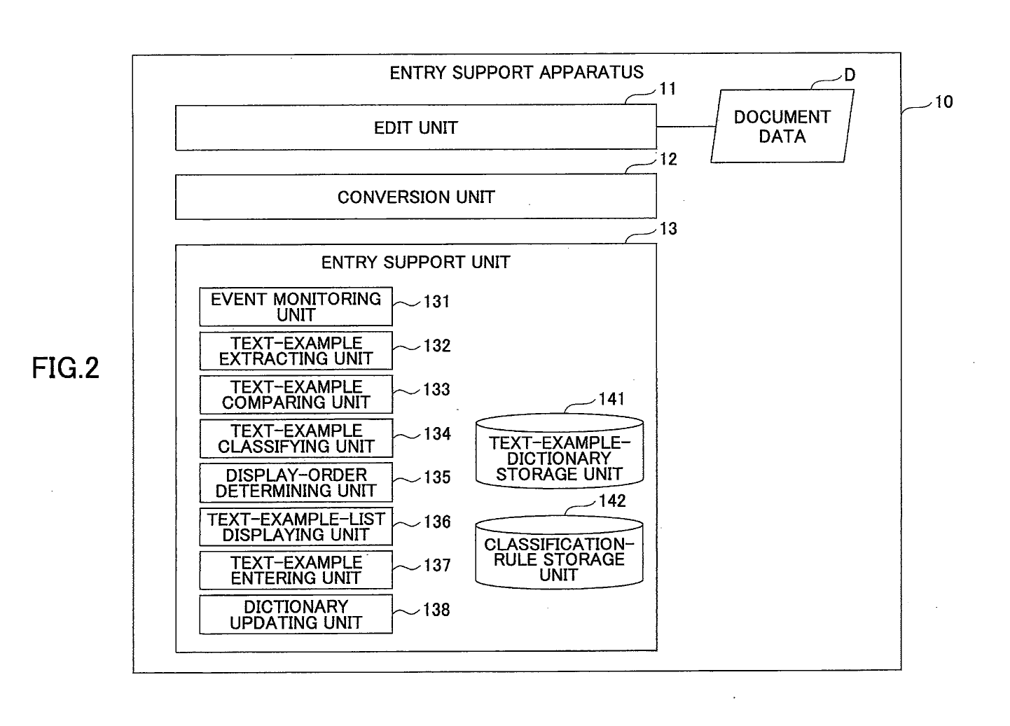

FIG. 2 is a drawing illustrating an example of the functional configuration of the entry support apparatus according to the present embodiment. In FIG. 1, the entry support apparatus includes an edit unit 11, a conversion unit 12, and an entry support unit 13.

The edit unit 11 performs tasks such as displaying, generating, and editing of document data D in response to user instructions entered through the input device 107. The edit unit 11 is implemented by processes that word processor software or the like causes the CPU 104 to perform.

The conversion unit 12 performs kava-to-kanji conversion with respect to letters entered into the document data D. Kane is a sillabary, and is used to represent the speech sound of text and also a reading of kanji characters contained in the text. The conversion unit 12 is an example of text-entry-purpose software referred to as IME (input method editor) or FTP (front end processor), for example. The conversion unit 12 is implemented by processes that kana-to-kanji conversion software causes the CPU 104 to perform.

The entry support unit 13 supports text entry into the document data D. The entry support unit 13 displays a list of text examples as candidate entries in response to a reading or unfixed character string being entered. The entry support unit 13 adds to the document data D the text example that is selected from the list.

In FIG. 2, the entry support unit 13 includes an event monitoring unit 131, a text-example extracting unit 132, a text-example comparing unit 133, a text-example classifying unit 134, a display-order determining unit 135, a text-example-list displaying unit 136, a text-example entering unit 137, a dictionary updating unit 138, a text-example-dictionary storage unit 141, and a classification-rule storage unit 142. The text-example-dictionary storage unit 141 and the classification-rule storage unit 142 may be implemented by the auxiliary storage device 102 or by another storage device or the like connected to the entry support apparatus 10 through a network.

The text-example-dictionary storage unit 141 stores therein a text-example dictionary. The text-example dictionary is a database in which text examples, corresponding readings, frequencies of use, and so on are stored. In the present embodiment, a text example may be a word, one or more phrases, a character string constituting a part of a sentence, or a character string including one or more sentences.

The event monitoring unit 131 monitors an entry event occurring at the entry support apparatus 10 to detect text entry. An entry event may be an event that a user makes an entry by using the input device 107.

The text-example extracting unit 132 extracts (retrieves), in response to text entry, matching text examples from the text-example-dictionary storage unit 141. Text examples matching the entered text may be the text examples that include the entered text as part of their readings.

The text-example comparing unit 133 compares letters included in the extracted text examples. More specifically, the text-example comparing unit 133 compares letters included in the extracted text examples with respect to their commonalities or similarities.

Based on the results of comparison made by the text-example comparing unit 133 (i.e., based on the commonalities or similarities of the text examples), the text-example classifying unit 134 classifies the extracted text examples into a plurality of groups (hereinafter referred to as “text-example groups”) each including one or more text examples. The classification-rule storage unit 142 stores therein rules about the classification of the extracted text examples into the text-example groups.

The display-order determining unit 135 determines the order in which the text examples are displayed. In the present embodiment, the display-order determining unit 135 determines the display order in units of text-example groups. Specifically, the display order of text-example groups is determined based on the frequencies of use of text examples included in the individual text-example groups.

The text-example-list displaying unit 136 displays the extracted text examples in the display order determined by the display-order determining unit 135. The text-example entering unit 137 adds the text example selected from the displayed list of text examples to the document data D that is being edited by the edit unit 11. The dictionary updating unit 138 updates the frequency of use in the text-example dictionary with respect to the added text example.

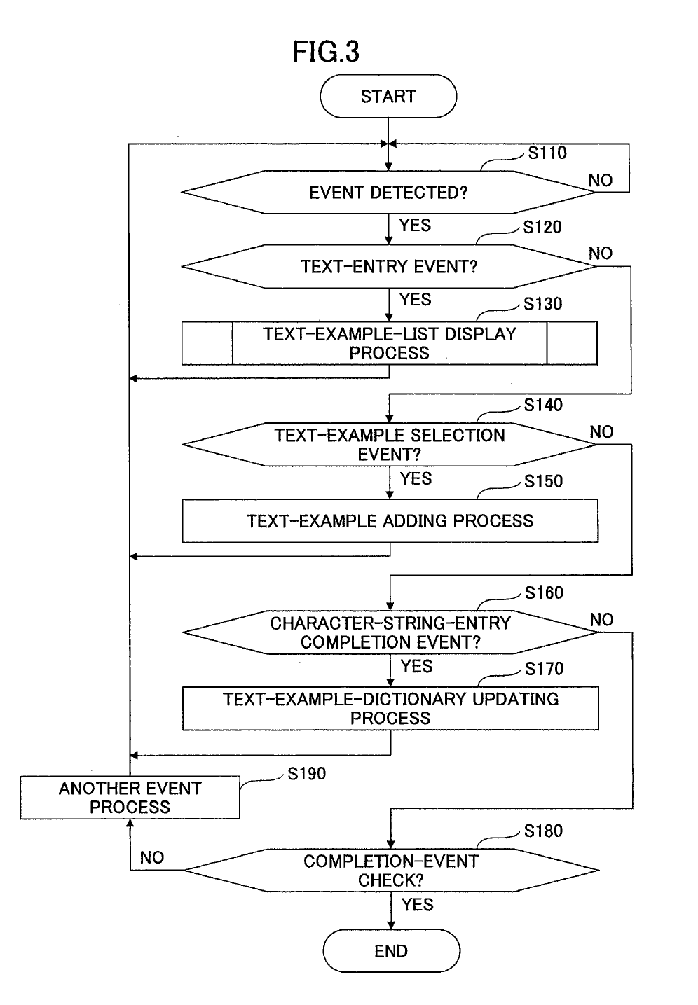

In the following, an operation procedure performed by the entry support apparatus 10 will be described. FIG. 3 is a flowchart for explaining the operation procedure performed by the entry support unit.

Upon the entry support unit 13 being activated as a process, for example, the event monitoring unit 131 of the entry support unit 13 monitors an entry event occurring at the entry support apparatus 10. Upon detection of an entry event by the event monitoring unit 131 (Yes in S110), the entry support unit 13 performs a process responsive to the entry event.

In the case of the detected entry event being a text-entry event (Yes in S120), the entry support unit 13 performs a text-example-list display process (S130) by using the entered letter or character string as a reading or unfixed character string. As a result of the text-example-list display process, a list of text examples (i.e., text-example list) corresponding to the reading or unfixed character string is displayed on the display device 106 as candidate texts for addition to the document data D. Here, a text-entry event refers to an event that text is entered.

In the case of the entry event being a text-example selection event (Yes in S140), the text-example entering unit 137 performs a text-example adding process (S150). By the text-example adding process, the text example selected from the list of text examples displayed by the text-example-list display process is added to the document data D. Here, a text-example-selection event refers to an event that a text example is selected from a list of text examples.

In the case of the entry event being a character-string-entry completion event (Yes in S160), the dictionary updating unit 138 performs a text-example-dictionary updating process (S170).

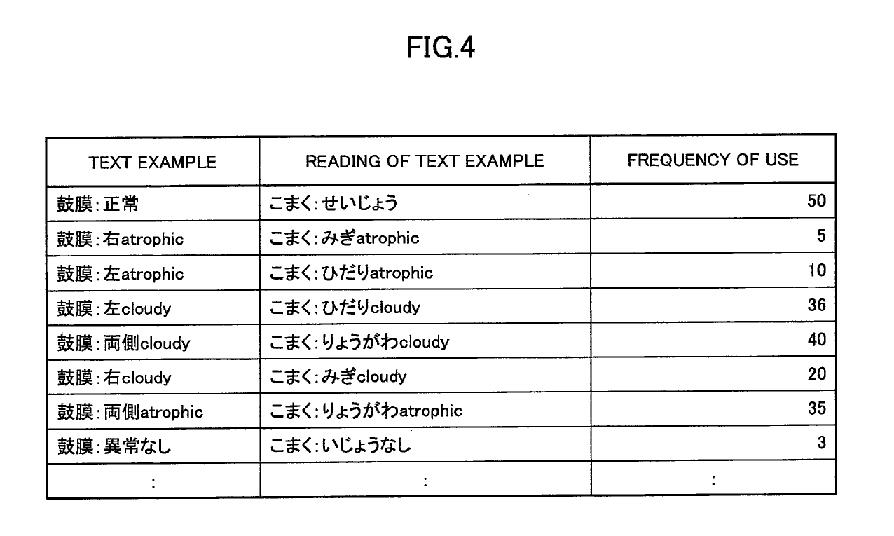

FIG. 4 is a drawing illustrating an example of the configuration of the text-example dictionary. In FIG. 4, the text-example dictionary includes a text example, a reading of the text example, and the frequency of use of the text example on a text-example-specific basis.

A reading of a text example is comprised of letters representing the speech sound of the text example. The frequency of use represents the frequency of the text example being used (i.e., being selected as a desired text). In the present embodiment, the frequency of use refers to the cumulative number of times the text example has been used. Alternatively, the frequency of use may refer to the number of times the text example was used during a period of predetermined length in the past (e.g., a period of few days in the past). FIG. 4 illustrates text examples that may be used in a medical document (e.g., electronic medical record). It may be noted that text examples entered in the text-example dictionary may be modified according to user need.

In step S170 described above, the dictionary updating unit 138 adds 1 to the frequency of use included in the text-example dictionary that is associated with the text example selected from the text-example list.

In the case of the entry event being a completion event (Yes in S180), the process of the entry support unit 13 comes to an end. Here, a completion event refers to an event that an instruction indicative of completion is entered to the entry support unit 13.

In the case of the entry event being other than the above-noted events (No in S180), the entry support unit 13 performs a process responsive to the event according to need (S190).

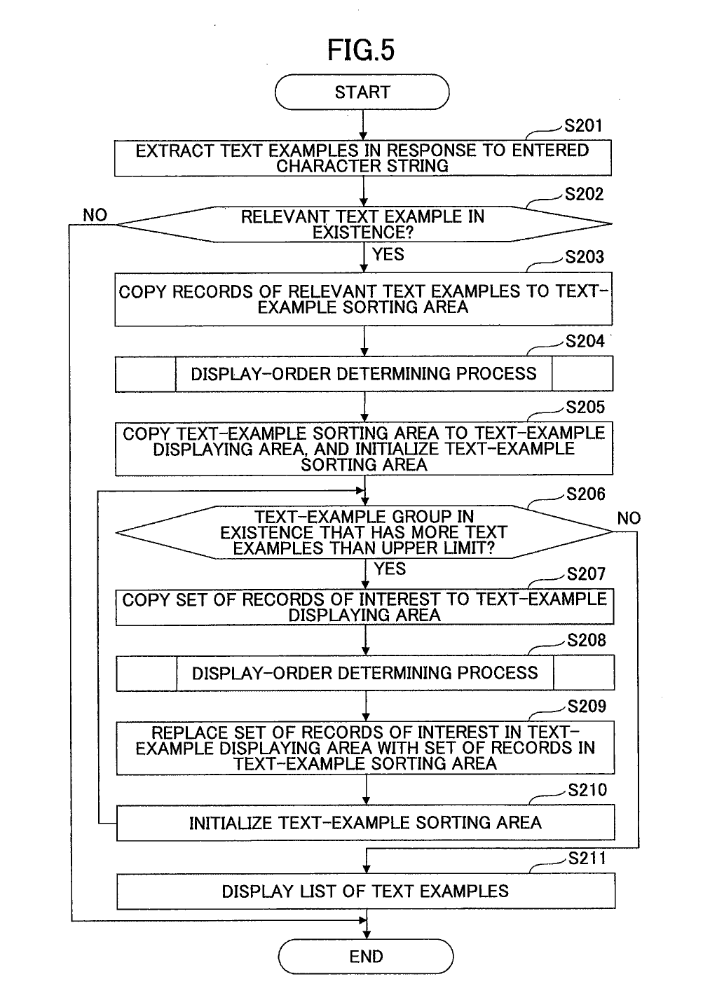

In the following, the detail of step S130 will be described. FIG. 5 is a flowchart illustrating an example of the steps of the text-example-list display process.

In step S201, the text-example extracting unit 132 extracts (retrieves) text examples corresponding to the entered reading or unfixed character string from the text-example dictionary stored in the text-example-dictionary storage unit 141.

Here, the text examples corresponding to the entered reading or unfixed character string refer to text examples whose readings at least partially match the entered reading or text examples that match the entered unfixed character string at least partially. The reading that at least partially matches the entered reading may be a reading of a text example whose head part is the same as the entered reading. In this case, the entirety of the reading of the text example may be the same as the entered reading, or only a head part of the reading of the text example may be the same as the entered text. The text example that at least partially matches the entered unfixed character string may be a text example whose head part is the same as the entered unfixed character string. In this case, the entirety of the text example may be the same as the entered unfixed character string, or only a head part of the text example may be the same as the entered unfixed character string. Here, the unfixed character string refers to a character string that is converted from an entered reading by the kana-to-kanji conversion unit 12 and that is not yet fixed as an entered text.

When no relevant text example is extracted (No in S202), the procedure illustrated in FIG. 5 comes to an end. When one or more relevant text examples are extracted (Yes in S202), the text-example comparing unit 133 copies records relating to the extracted text examples from the text-example dictionary to a text-example sorting area (S203). Here, the text-example sorting area is a memory-space work area for sorting the extracted text examples to change their sequence, and may be implemented by the memory device 103, for example.

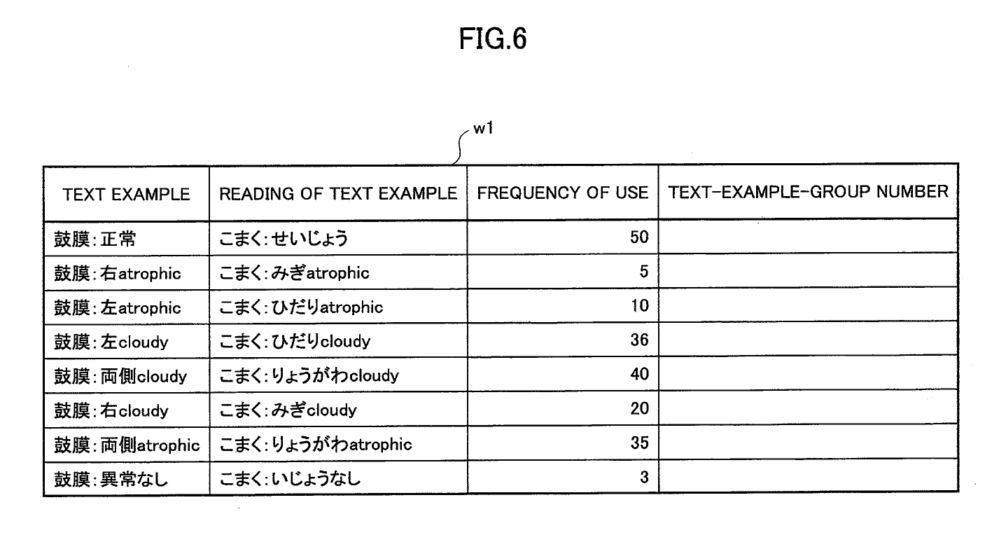

FIG. 6 is a drawing illustrating an example of the configuration of the text-example sorting area. FIG. 6 illustrates an example of a text-example sorting area w1 for the text examples extracted from the text-example dictionary illustrated in FIG. 4 when the letters “ [symbol] ” are entered as a reading. In this case, text examples whose first two letters of the reading are “ [symbol] ” are extracted.

As illustrated in FIG. 6, the text-example sorting area w1 has a format (or structure) in which a field (or column) for specifying text-example-group numbers is added to the text-example dictionary. In step S203, therefore, the readings and the frequencies of use of the extracted text examples are set in the text-example sorting area w1. The text-example-group numbers are identification numbers for identifying text-example groups that are created by classifying the extracted text examples based on the commonalities or similarities of letters included in the extracted text examples.

The text-example sorting area w1 suffices if it can store the extracted text examples. The provision of records (rows) equal in number to the number of the extracted text examples is thus sufficient, which is different from the text-example dictionary.

Any order of text examples in the text-example sorting area w1 is acceptable when step S203 is performed. For example, the order of text examples may be the same as the order in which they are extracted from the text-example dictionary.

The text-example comparing unit 133, the text-example classifying unit 134, the display-order determining unit 135, and the like perform a display-order determining process with respect to the text examples set in the text-example sorting area w1 (S204).

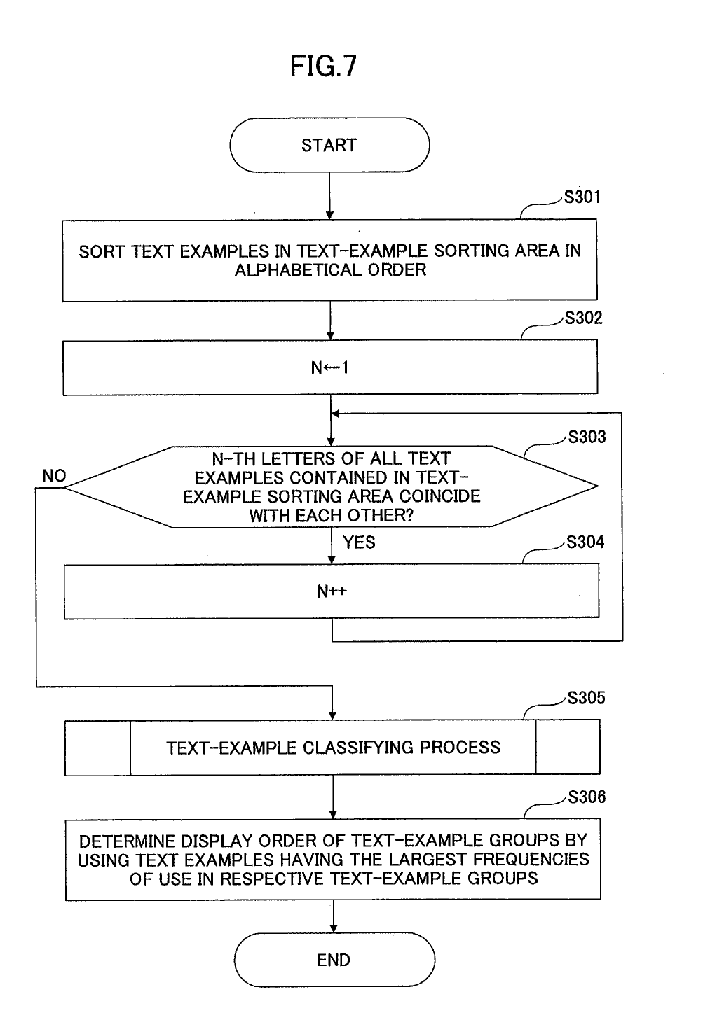

The detail of the display-order determining process will now be described. FIG. 7 is a flowchart illustrating an example of the steps of the display-order determining process.

In step S301, the text-example comparing unit 133 sorts the records in the text-example sorting area w1, thereby arranging the text examples (readings of the text examples, to be exact) in ascending kana-character order. When alphabets and/or numerals are included, alphabetical order and/or numerical order may also be used in combination. In the following, the term “alphabetical order” is used to refer to any combination of kava-character order, alphabetical order, and numerical order.

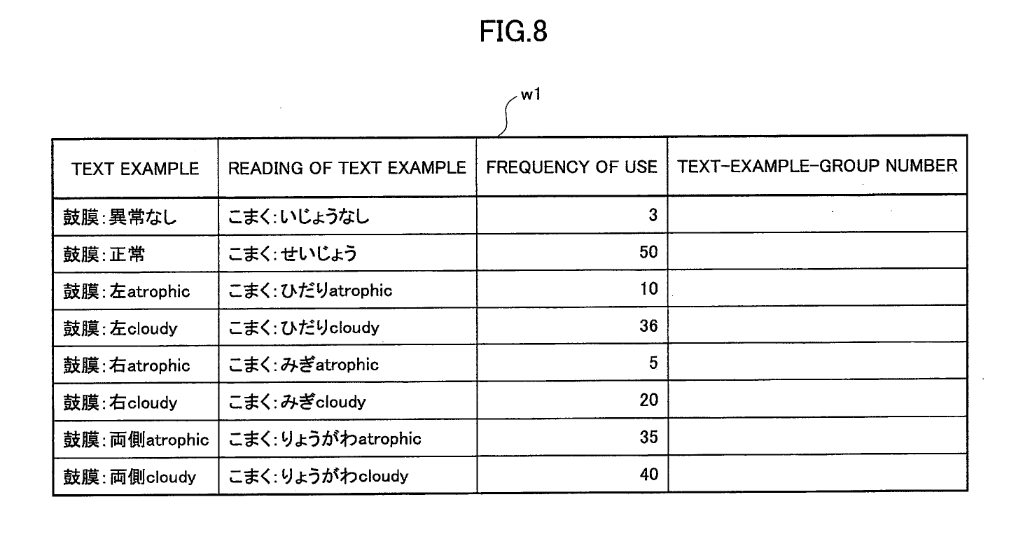

FIG. 8 is a drawing illustrating an example of the result of sorting according to alphabetical order. The records in the text-example sorting area w1 illustrated in FIG. 8 are sorted into alphabetical order with respect to the readings of the text examples. Here, the alphabetical-order-based sort is an example in which comparison of commonalities or similarities contained in individual text examples is made. Namely, when text examples are sorted according to alphabetical order, the text examples having character commonalities or similarities with each other are arranged alongside or in close proximity with each other. Alphabetical order may be a reverse alphabetical order like “z” to “a”. However, a normal alphabetical order may generally be easier for a user to deal with.

The text-example classifying unit 134 initializes the value of variable N to 1 (S302). The text-example classifying unit 134 then checks whether the N-th letters of all the text examples contained in the text-example sorting area w1 coincide with each other (i.e., are the same) (S303). When the N-th letters of all the text examples coincide with each other (Yes in S303), the text-example classifying unit 134 adds 1 to N, and performs step S303 again.

When at least one text example has the N-th letter that is different from the N-th letters of the remaining text examples (No in S303), the text-example classifying unit 134 performs a text-example classifying process (S305). In the text-example classifying process, the text examples contained in the text-example sorting area w1 are classified into text-example groups based on the sameness of the N-th letters. As a result, each record of the text-example sorting area w1 receives, as a new item entered therein, a text-example-group number indicative of the text-example group into which the record is classified.

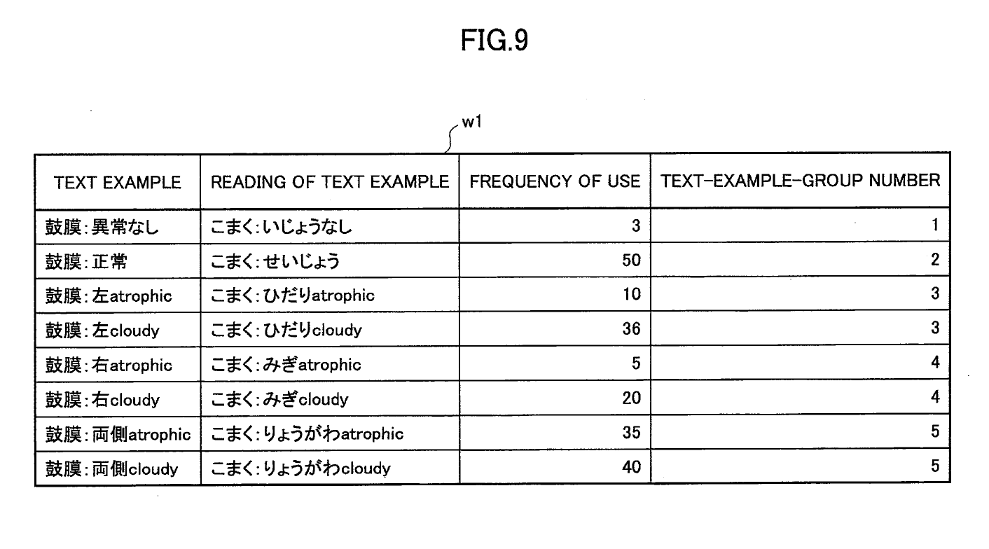

FIG. 9 is a drawing illustrating an example of a result obtained by classifying text examples into groups. In the present embodiment, all the text examples contained in the text-example sorting area w1 are identical to each other up to the third letters thereof (i.e., share the same three letters “ [symbol] :”, wherein “ [symbol] ” means an “eardrum”). Accordingly, all the text examples are classified into five text-example groups based on the sameness of the fourth letters. Specifically, the first record is given the text-example-group number “1”. The second record is given the text-example-group number “2”. The text example of the first record and the text example of the second record each make up a single text-example group as a sole member of the group. The name of a text-example group may be defined as “text-example group <text-example-group number>”.

The third and fourth records are given the text-example-group number “3”. The text examples of the third and fourth records have the same fourth letters, so that they belong to the same text-example group. Namely, the text example of the third record and the text example of the fourth record together make up a text-example group 3. By the same token, the text examples of the fifth and sixth records together constitute a text-example group 4, and the text examples of the seventh and eighth records together constitute a text-example group 5.

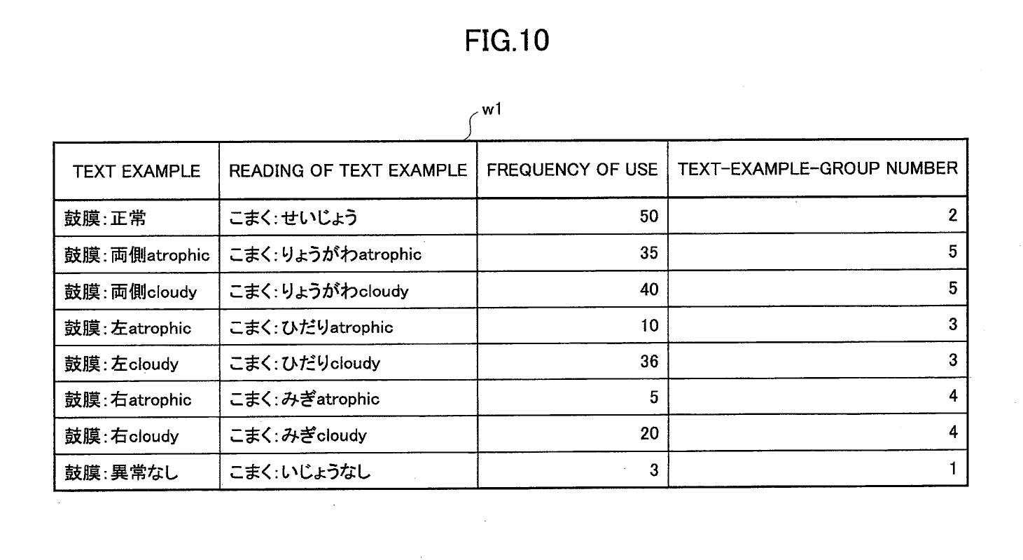

Thereafter, the display-order determining unit 135 determines display order in units of text-example groups, and updates the order in which records are arranged in the text-example sorting area w1 according to the determined display order (S306). To be more specific, the display order is determined in units of text-example groups as follows. The display-order determining unit 135 finds the largest value of the frequencies of use with respect to the text examples belonging to each text-example group. The largest value is identified for each text-example group. The display-order determining unit 135 then sorts the text-example groups in the descending order of the largest values. Namely, sorting is performed such that the higher the frequency of use of a text example included in a text-example group, the upper the position of the text-example group is in the display order. Consequently, the text-example sorting area w1 illustrated in FIG. 9 is updated to the one illustrated in FIG. 10.

FIG. 10 is a drawing illustrating an example of a result obtained by sorting the text-example groups. In FIG. 10, the text-example groups are arranged in the following order: text-example group 2→text-example group 5→text-example group 3→text-example group 4→text-example group 1. The largest value of the frequency of use in the text-example group 2 is 50. The largest value of the frequency of use in the text-example group 3 is 40. The largest value of the frequency of use in the text-example group 3 is 36. The largest value of the frequency of use in the text-example group 4 is 20. The largest value of the frequency of use in the text-example group 1 is 3. FIG. 10 illustrates the result obtained by sorting the text-example groups in the descending order of these largest values.

It may be noted that the display order of text-example groups may be determined by other criteria different from the largest values of the frequencies of use in the text-example groups. For example, the display order of text-example groups may be determined based on an average value of the frequencies of use of text examples belonging to each text-example group.

The arrangement of text examples in each text-example group is the same as the arrangement used in S301 (i.e., alphabetical order). A user may know that the order of text examples within each text-example group, which is comprised of text examples having high commonalities or similarities, is alphabetical order. In such a case, it would be easy for the user to find a desired text, example.

Alternatively, the display-order determining unit 135 may arrange the text examples in each text-example group in the descending order of frequencies of use of the text examples. In this case, the frequency of use is given more emphasis in the display order of text examples. This arrangement can improve the operability of a text-example list for a user who feels increased usability if the higher the frequency of use of a text example, the upper the position of the text example is.

Further, the commonalities or similarities of extracted text examples may be determined based on similarities between the text examples. Similarities may be calculated based on the number of consecutive letters that are identical between the text examples. Text examples having such a calculated similarity larger than a predetermined value may be classified into the same text-example group.

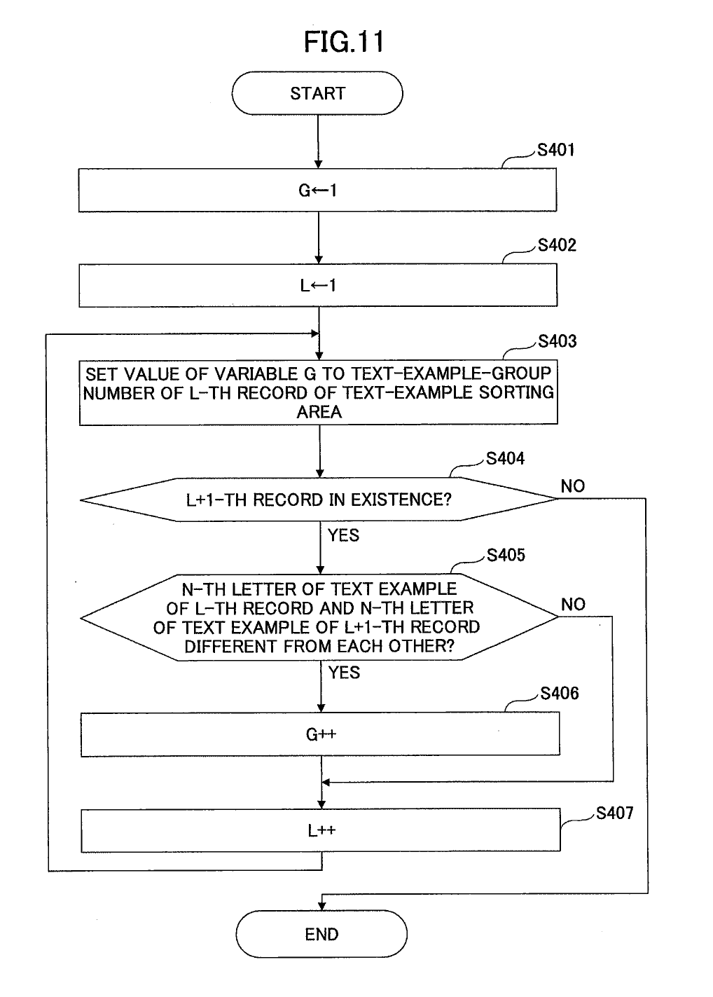

In the following, the detail of step S305 will be described. FIG. 11 is a flowchart illustrating an example of the steps of the text-example classifying process. The procedure illustrated in FIG. 11 serves to change the text-example sorting area w1 of the present embodiment from the state illustrated in FIG. 8 to the state illustrated in FIG. 9.

In step S401, the text-example classifying unit 134 initializes the value of variable G to 1. Variable G represents a text-example-group number. The text-example classifying unit 134 further initializes the value of variable L to 1 (S402). Variable L represents the row number of a record that is to be processed in the text-example sorting area w1.

The text-example classifying unit 134 sets the value of variable G to the text-example-group number of the L-th record of the text-example sorting area w1 (S403). In the example illustrated in FIG. 8, for example, the first record is given the text-example-group number “1”.

Following that, the text-example classifying unit 134 checks whether there is an L+1-th record in the text-example sorting area w1 (i.e., whether there is a record following the L-th record) (S404). When there is an L+1-th record (Yes in S404), the text-example classifying unit 134 checks whether the N-th letter of the text example of the L-th record and the N-th letter of the text example of the L+1-th record are different from each other (S405). Here, the value of N is equal to the value of N that is observed immediately prior to the execution of step S305 in FIG. 7. In the example of FIG. 8, thus, the fourth letter “ [symbol] ” of the first text example “ [symbol] ” and the fourth letter “ [symbol] ” of the second text example “ [symbol] ” are compared, wherein “ [symbol] ” means an “eardrum”.

When the N-th letters of the text examples compared with each other are different (Yes in S405, the text-example classifying unit 134 adds 1 to variable G (S406). Following step S406 or upon detecting “No” in step S405, the text-example classifying unit 134 adds 1 to variable L (S407). The text-example classifying unit 134 then repeats step S403 and the subsequent steps. In the example illustrated in FIG. 8, the second record is given the text-example-group number “2” in step S403 that is performed the second time. In step S405 that is performed the second time, the fourth letter “ [symbol] ” of the second text example “ [symbol] ” and the fourth letter “ [symbol] ” of the third text example “ [symbol] atrophic” are compared, wherein “ [symbol] ” means an “eardrum”.

When step S403 and the subsequent steps are repeated and the value of variable L becomes equal to the number of records in the text-example sorting area w1 (No in step S404), the procedure of FIG. 11 comes to an end. At the end of the procedure illustrated in FIG. 11, the text-example sorting area w1 is in the state illustrated in FIG. 9.

In the manner as described above, the text-example classifying unit 134 identifies the letter position (i.e., N-th position) at which a letter differing between the extracted text examples first appears, and classifies the extracted text examples into text-example groups based on the sameness of the letters at the identified position of the extracted text examples.

Referring to FIG. 5 again, following step S204 (i.e., the procedures illustrated in FIG. 7 and FIG. 11), the text-example-list displaying unit 136 copies the records (FIG. 10) of the text-example sorting area w1 to a text-example displaying area w2, and then initializes the text-example sorting area w1 (S205). The initialization of the text-example sorting area w1 means clearing all the records in the text-example sorting area w1. Further, the text-example displaying area w2 is a memory-space work area for displaying a list of text examples, and may be implemented by the memory device 103, for example. The structure of the text-example displaying area w2 may be the same as the structure of the text-example sorting area w1.

The text-example-list displaying unit 136 refers to the text-example displaying area w2 to check whether there is a text-example group that has a larger number of text examples than the upper limit (S206). In the present embodiment, the upper limit is stored in the classification-rule storage unit 142.

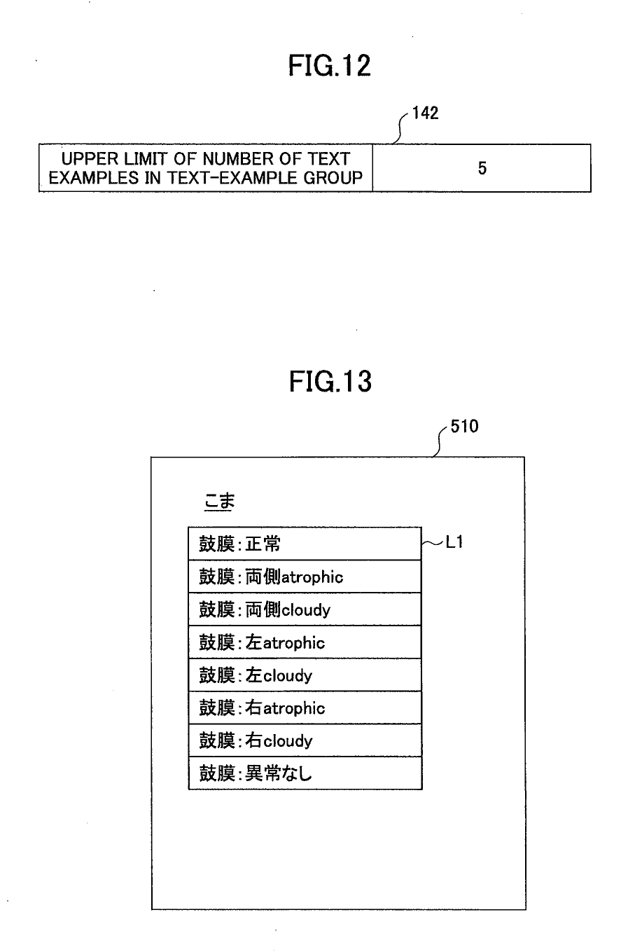

FIG. 12 is a drawing illustrating an example of the configuration of the classification-rule storage unit 142. In FIG. 12, the classification-rule storage unit 142 stores the upper limit of the number of text examples in a text-example group. The upper limit of the number of text examples represents the maximum number of text examples allowed to belong to a single text-example group. The check in step S206 is made by referring to the upper limit of the number of text examples in a text-example group stored in the classification-rule storage unit 142.

When there is a text-example group that has more text examples than the upper limit (Yes in S206), the text-example-list displaying unit 136 copies a set of records belonging to this text-example group to the text-example sorting area w1 (S207). This copied set of records will hereinafter be referred to as the “set of records of interest”. After this, the display-order determining process is performed with respect to the text-example sorting area w1 that has the set of records of interests copied thereto (S208). The display-order determining process has already been described with reference to FIG. 7 and FIG. 11. In this display-order determining process, the text examples belonging to the set of records of interest are classified into text-example groups (i.e., text-example sub-groups), followed by determining the display order of the text-example sub-groups.

The display-order determining process is recursively performed with respect to the text-example groups into which text examples have already been classified, so that a text-example group having a large number of text examples can be further divided into groups, and the display order can then be determined in units of text-example sub-groups obtained by such a further division. In so doing, the display order may be determined according to the largest values of the frequencies of use of text examples included in the respective text-example sub-groups. In this manner, when there is a text-example group having a large number of text examples among the text-example groups that are classified first (i.e., first-hierarchical-level classification groups), commonalities or similarities as well as the frequencies of use are further compared between the text examples, thereby determining the order of arrangement (i.e., display order).

The text-example-list displaying unit 136 replaces the set of records of interest in the text-example displaying area w2 with the set of records of the text-example sorting area w1 (S209). In the text-example displaying area w2, there is no change in the order in which the text-example groups are displayed. The text-example-list displaying unit 136 then initializes the text-example sorting area w1 (S210), followed by repeating step S206 and the subsequent steps.

When there is no text-example group that has more text examples than the upper limit (No in S206), the text-example-list displaying unit 136 displays a list of text examples on the display device 106 arranged in the order in which the text examples are arranged in the text-example displaying area w2 (S211).

FIG. 13 is a drawing illustrating an example of the way a list of text examples is displayed. In FIG. 13, a text-example list L1 is displayed in response to entering the reading “ [symbol] ” on a document edit screen 510 that is displayed on the display device 106 by the edit unit 11. The contents of the text-example list L1 corresponds to the data illustrated in FIG. 10. In the text-example list L1, text examples having close commonalities or similarities are arranged alongside or in a close proximity to each other, so that it is easy to visually recognize differences between the text examples. Further, the text-example groups are arranged according to the frequencies of use of text examples contained in these groups, so that the higher the frequency of use of a text example, generally the upper the position of this text example is. In the text-example list L1, it is easy to select a text example that has a high frequency of use.

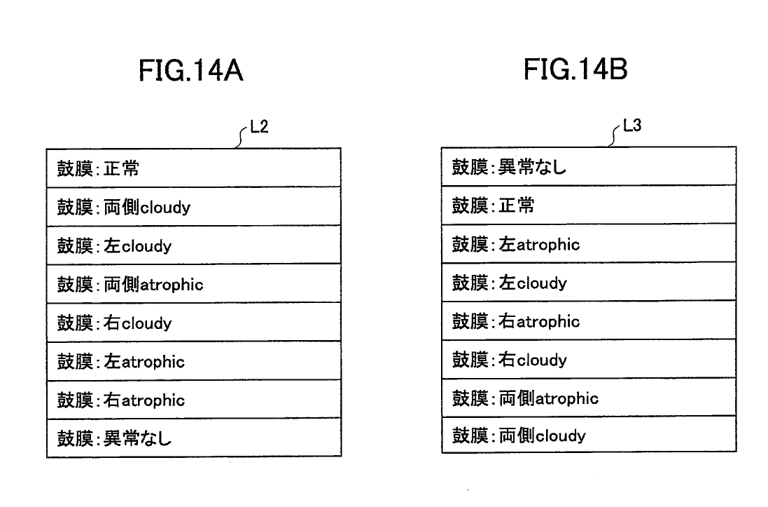

A display order in which the text examples of the text-example list L1 are arranged solely based on the frequencies of use and a display order in which the text examples are arranged in alphabetical order are illustrated in FIGS. 14A and 14B for comparison purposes.

FIGS. 14A and 14B are drawings illustrating examples of a text-example list displayed in the order of frequencies of use and in alphabetical order, respectively. A text-example list L2 is an example of arrangement according to the order of frequencies of use. In the text-example list L2, text examples having close commonalities or similarities are placed far apart from each other, which makes it difficult to compare such text examples with each other.

A text-example list L3 is an example of arrangement according to alphabetical order. In the text-example list L3, the text example that has the lowest frequency of use is displayed at the top. With this arrangement, the operation to select a desired text may become more cumbersome. The selection of a text example may be performed by pressing a TAB key or the like. When text examples having low frequencies of use are placed at top positions, the number of times the TAB key or the like is pressed increases.

As described above, according to the present embodiment, text examples matching an entered reading are classified into text-example groups based on the commonalities or similarities of letters included in the text examples, and display order is determined in units of text-example groups. In so doing, the display order of text-example groups may be determined according to the frequencies of use of text examples (i.e., the numbers of previous uses of text examples) included in the text-example groups. In this manner, the ease of comparison between text examples having close commonalities or similarities and the ease of selecting a text example having a high frequency of use are properly balanced in the task of displaying a list of text examples. As a result, the efficiency of text-example selection can be maintained while reducing the possibility of selection mistake.

In the present embodiment, the event monitoring unit 131 is an example of a detection unit. The text-example extracting unit 132 is an example of an extraction unit. The text-example classifying unit 134 is an example of a classification unit. The display-order determining unit 135 is an example of a determination unit. The text-example-list displaying unit 136 is an example of a display unit. The text-example-dictionary storage unit 141 is an example of a storage unit.

Further, the present invention is not limited to these embodiments, but various variations and modifications may be made without departing from the scope of the present invention.

According to an embodiment, it becomes easier to find a desired text among a list of text examples.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium having an entry support program embodied therein for causing a computer to perform:
detecting text being entered;
extracting text examples corresponding to the detected text from a storage unit, the storage unit storing text examples and frequencies of use of the text examples such that the frequencies of use are associated with the respective text examples;
classifying the extracted text examples into text-example groups each containing one or more text examples based on comparison of letters included in the extracted text examples;
determining display order of the text-example groups, based on the frequencies of use that are associated in the storage unit with text examples belonging to the text-example groups; and
displaying the extracted text examples in the determined display order.

2. The computer-readable recording medium as claimed in claim 1, wherein the determining display order includes determining display order of text examples belonging to a given one of the text-example groups according to order defined based on letters included in the text examples belonging to the given one of the text-example groups.

3. The computer-readable recording medium as claimed in claim 1, wherein the determining display order includes determining display order of text examples belonging to a given one of the text-example groups, based on the frequencies of use that are associated in the storage unit with the text examples belonging to the given one of the text-example groups.

4. The computer-readable recording medium as claimed in claim 1, wherein the entry support program causes the computer to further perform:
making a comparison of letters included in text examples belonging to one of the text-example groups; and
classifying the text examples belonging to the one of the text-example groups into text-example sub-groups each containing one or more text examples based on a result of the comparison.

5. The computer-readable recording medium as claimed in claim 1, wherein the classifying the extracted text examples identifies a letter position at which a letter differing between the extracted text examples first appears, and classifies the extracted text examples into the text-example groups based on sameness of letters at the identified position of the extracted text examples.

6. An entry support apparatus, comprising:
a detection unit configured to detect text being entered;
an extraction unit configured to extract text examples corresponding to the detected text from a storage unit, the storage unit storing text examples and frequencies of use of the text examples such that the frequencies of use are associated with the respective text examples;
a classification unit configured to classify the extracted text examples into text-example groups each containing one or more text examples based on comparison of letters included in the extracted text examples;
a determination unit configured to determine display order of the text-example groups, based on the frequencies of use that are associated in the storage unit with text examples belonging to the text-example groups; and
a display unit configured to display the extracted text examples in the determined display order.

7. An entry support method, comprising as processes performed by a computer:
detecting text being entered;
extracting text examples corresponding to the detected text from a storage unit, the storage unit storing text examples and frequencies of use of the text examples such that the frequencies of use are associated with the respective text examples;
classifying the extracted text examples into text-example groups each containing one or more text examples based on comparison of letters included in the extracted text examples;
determining display order of the text-example groups, based on the frequencies of use that are associated in the storage unit with text examples belonging to the text-example groups; and
displaying the extracted text examples in the determined display order.
